(19) United States
(12) Patent Application Publication
(10) Pub. No.: US 2014/0002814 A1
(43) Pub. Date: Jan. 2, 2014

(54) OBSERVATION DEVICE AND OBSERVATION METHOD

(71) Applicant: NIKON CORPORATION, Tokyo (JP)

(72) Inventors: Naoshi SAKAGUCHI, Kawasaki-shi (JP); Takashi WATANABE, Naka-gun (JP); Masashi TAKAHASHI, Yokohama-shi (JP); Hiroaki OKAMOTO, Yokohama-shi (JP)

(73) Assignee: NIKON CORPORATION, Tokyo (JP)

(21) Appl. No.: 14/014,343

(22) Filed: Aug. 29, 2013

Related U.S. Application Data
(62) Division of application No. 12/916,062, filed on Oct. 29, 2010.
Application No. 12/916,062 is a continuation of application No. PCT/JP2009/058271, filed on Apr. 27, 2009.

(30) Foreign Application Priority Data
Apr. 30, 2008 (JP) 2008-118931

(51) Int. Cl. G01N 21/95

(52) U.S. Cl. CPC G01N 21/9501
USPC 356/237.4

(57) ABSTRACT

An observation device (1) for observing a portion near the end of a wafer (10), comprising an imaging section (40) for Imaging an image near the end of a wafer (10) from the extending direction of the wafer (10), and an image processing section (50) for detecting the edge of a film formed on the surface of the wafer (10) is further provided, as an illumination section for illuminating a portion near the end of a wafer (10), with an epi-illumination source (48) for illuminating a portion near the end of a wafer (10) via an observation optical system (41), and a diffusion illumination source (31) arranged to face the surface of the wafer (10) and illuminate a portion near the end of a wafer (10) using diffused light.

### TECHNICAL FIELD

The present invention relates to an observation device and an observation method for observing semiconductor wafers, liquid-crystal glass substrates, and other substrates.

### TECHNICAL BACKGROUND

Over the past several years, the degree of integration of circuit element patterns formed on a semiconductor wafer is progressing and the types of thin films used in wafer surface treatments in semiconductor manufacturing steps is increasing. In accordance therewith, it is becoming increasingly important to detect defects near the end of a wafer where the edge (boundary portion) of the thin film is exposed. When foreign matter is present near the end of a wafer, it wraps around to the surface side of the wafer, produces an adverse effect in later steps, and affects the yield of circuit elements created from a wafer.

In view of the above, inspection devices have been considered (e.g., see Patent Document 1) for observing the periphery (e.g., apex and vertical bevel) of the end of a semiconductor wafer or another circularly formed substrate, and for inspecting the existence of foreign matter, film peeling, bubbles in the film, defects, film wraparound, and other adverse events. Examples of methods that are used for detecting the position of the edge (boundary portion) of the film using such a inspection device include a method for observing the vicinity of the apex in a single process from a direction substantially parallel (lateral direction of the substrate) to the flat portion of the substrate using an optical system with a high depth of focus, and a method for observing the upper-side bevel in which the edge of the film appears using an optical system that faces in a direction diagonal to the flat portion of the substrate.

### CITATION LIST

### Patent Document

Patent Document 1: Japanese Laid-open Patent Publication No. 2004-325389

### SUMMARY OF INVENTION

### Problems to be Solved by the Invention

However, the numerical aperture of the optical system must be kept low when the vicinity of the apex is to be observed in a single process using an optical system with a high depth of focus. Therefore, the edge of the film is detected using an image with an unclear image of the edge (boundary portion) of the film, and errors are liable to occur when the position of the edge of the film is to be detected.

The present invention was developed in view of the problems described above, and an object of the present invention is to provide an observation device and observation method that can detect with high precision the edge of a film formed on the surface of a substrate.

### Means to Solve the Problems

In order to achieve the objects described above, the observation device according to the present invention is an observation device comprising a holding mechanism for holding a substrate; and an imaging section for imaging the vicinity of an end of the substrate from a direction in which the substrate extends, the substrate being held in the holding mechanism, wherein the vicinity of the end of the substrate is observed using the image of the vicinity of the end of the substrate imaged and obtained by the imaging section, the observation device being configured such that a surface of the substrate has a sloped portion that is formed in the vicinity of the end of the substrate and that slopes toward the end, and a flat portion that is substantially flat and formed inside the sloped portion, wherein an edge of a film formed on the surface of the substrate is positioned on the sloped portion. The observation device has: an illumination section for illuminating the vicinity of the end of the substrate in order to capture an image using the imaging section; and a film detection section for detecting the edge of the film using the image of the vicinity of the end of the substrate imaged by the imaging section, wherein the imaging section has an observation optical system for forming an image of the vicinity of the end of the substrate, and an imaging element for imaging an image of the vicinity of the end of the substrate formed by the observation optical system; and the illumination section has an epi-illumination source for illuminating the vicinity of the end of the substrate via the observation optical system, and a diffusion illumination source for illuminating the vicinity of the end of the substrate using diffused light, the diffusion illumination source being arranged so as to face the surface of the substrate.

In the observation device described above, preferably, the imaging section has a focus point changing section for modifying a focus position on the substrate on the object side of the observation optical system, and forms an image of the vicinity of the end of the substrate using the imaging element in a state in which the focus position has been placed by the focus point changing section on the boundary portion between the sloped portion and the flat portion as well as on the edge of the film; and that the film detection section calculates the distance between the flat portion and the edge of the film in the thickness direction of the substrate using an image of the vicinity of the end of the substrate in which the focus position has been placed on the boundary portion between the sloped portion and the flat portion, and an image of the vicinity of the end of the substrate in which the focus position has been placed on the edge of the film.

In the observation device described above, preferably, the observation device described above comprises a correlation measurement unit for using an image of the vicinity of the end of the substrate in which the focus position has been placed on the boundary portion between the sloped portion and the flat portion, and an image of the vicinity of the end of the substrate in which the focus position has been placed on the edge of the film, to calculate a correlation between image information of the flat portion imaged away from the focus position and the position of the actual flat portion of the image in the image wherein the focus position has been placed on the edge portion of the film, wherein the film detection section detects the position of the edge of the film, detects the position of the flat portion using the correlation calculated by the correlation measurement section, and calculates the distance between the flat portion and the edge of the film in the thickness direction of the substrate, on the basis of the image in the vicinity of the end of the substrate in which the focus point has been placed on the edge of the film.

In the observation device described above, preferably, the holding mechanism rotatably holds the substrate using as the axis of rotation the axis of rotational symmetry of the substrate, which is substantially circularly formed; the imaging section continuously images the vicinity of the end of the substrate over the entire periphery of the substrate rotatably driven by the holding mechanism; and the film detection section determines, over the entire periphery of the substrate, the distance between the flat portion and the edge portion of the film in the thickness direction of the substrate.

In the observation device described above, preferably, the holding mechanism holds the substrate so as to enable parallel movement; and the focus point changing section moves the substrate parallel to the optical axis of the observation optical system using the holding mechanism and thereby changes the focus position of the observation optical system on the substrate.

In the observation device described above, preferably, the focus point changing section moves any of the optical elements in the observation optical system along the optical axis of the observation optical system and thereby changes the focus position of the observation optical system on the substrate.

In the observation device described above, preferably, the imaging section images an image of the vicinity of the end of the substrate using the imaging element in a state in which the focus position of the observation optical system has been placed on the edge of the film; and the film detection section detects the position of the edge of the film, detects the center position in the thickness direction of the substrate and the position of the flat portion relative to a thickness of the substrate stored in advance, and calculates the distance between the flat portion and the edge of the film in the thickness direction of the substrate, on the basis of the image in the vicinity of the end of the substrate in which the focus position has been placed on the edge of the film.

The observation device described above preferably comprises an opposite-side illumination section for sending light parallel to the flat portion of the substrate toward the imaging section, the opposite-side illumination section being arranged on the opposite side of the substrate from the imaging section.

In the observation device described above, preferably, the imaging section is configured so as to allow an image of the vicinity of the end of the substrate to be imaged by the imaging element in a state in which the focus position of the observation optical system has been placed on the boundary portion between the sloped portion and the flat portion as well as on the edge of the film; and the film detection section detects, from the image imaged by the imaging section, the positions of the edge of the film and the boundary portion between the sloped portion and the flat portion imaged with the focus positions matched, and calculates the distance between the flat portion and the edge of the film in the thickness direction of the substrate.

The observation method according to the present invention is an observation method for observing the vicinity of an end of a substrate using an image of the vicinity of the end of the substrate imaged and obtained by an imaging section in an observation device comprising a holding mechanism for holding the substrate, and an imaging section for imaging an image in the vicinity of the end of the substrate from a direction in which the substrate extends, the substrate being held in the holding mechanism, wherein the surface of the substrate has a sloped portion that is formed in the vicinity of the end of the substrate and that slopes facing the end side, and a flat portion that is substantially flat and formed inside the sloped portion; and an edge of a film formed on the surface of the substrate is positioned on the sloped portion; and the imaging section has an observation optical system for forming an image of the vicinity of the end of the substrate, and an imaging element for imaging the image of the vicinity of the end of the substrate formed by the observation optical system. The method comprises an illumination step for illuminating the vicinity of the end of the substrate; an imaging step for imaging the illuminated vicinity of the end of the substrate using the imaging section; and a film detection step for detecting the edge of the film using an image of the vicinity of the end of the substrate imaged and obtained by the imaging section, wherein in the illumination step, the vicinity of the end of the substrate is illuminated by an epi-illumination source via the observation optical system and the vicinity of the end of the substrate is illuminated using illumination light.

The observation method described above preferably comprises, in the imaging step, forming an image of the vicinity of the end of the substrate using the imaging element in a state in which the focus position on an object side of the observation optical system has been placed on the boundary portion between the sloped portion and the flat portion as well as on the edge of the film; and in the film detection step, using an image of the vicinity of the end of the substrate in which the focus position has been placed on the boundary portion between the sloped portion and the flat portion, and an image of the vicinity of the end of the substrate in which the focus position has been placed on the edge of the film, to determine the distance between the flat portion and the edge of the film in the thickness direction of the substrate.

The observation method described above preferably comprises a correlation measurement step for using an image of the vicinity of the end of the substrate in which the focus position has been placed on the boundary portion between the sloped portion and the flat portion, and an image of the vicinity of the end of the substrate in which the focus position has been placed on the edge of the film, to determine a correlation between image information of the flat portion imaged away from the focus position and the position of the actual flat portion in the image, in the image in which the focus position has been placed on the edge portion of the film; and in the film detection step, detecting the position of the edge of the film, detecting the position of the flat portion using the correlation calculated by the correlation measurement step, and determining the distance between the flat portion and the edge of the film in the thickness direction of the substrate, on the basis of the image in the vicinity of the end of the substrate in which the focus position has been placed on the edge of the film.

The observation method described above preferably comprises the holding mechanism rotatably holding the substrate using as the axis of rotation the axis of rotational symmetry of the substrate, which is substantially circularly formed; the vicinity of the end of the substrate rotatably driven by the holding mechanism being continuously imaged over the entire periphery of the substrate using the imaging section in the imaging step; and the distance between the flat portion and the edge portion of the film in the thickness direction of the substrate being determined over the entire periphery of the substrate in the film detection step.

### Advantageous Effects of the Invention

In accordance with the present invention, the edge of the film formed on the surface of a substrate can be detected with high precision.

### BRIEF DESCRIPTION OF THE DRAWINGS

FIG. 1 is a schematic structure view of the observation device according to the present invention;

FIG. 2 is a side surface view showing the vicinity of the external periphery end of the wafer;

FIG. 3 is a control block view showing the image processing section;

FIG. 4 is a flowchart showing the observation method of the present invention;

FIG. 5A is a schematic view showing the state in which the focus position of the observation optical system has been placed on the edge of the protective film, and FIG. 5B is a schematic view showing the state in which the focus position of the observation optical system has been placed on the boundary portion between the upper bevel portion and the flat portion;

FIG. 6A is a schematic view showing an image of the vicinity of the apex portion in which the focus position of the observation optical system has been placed on the edge of the protective film, and FIG. 6B is an image of the vicinity of the apex portion in which the focus position of the observation optical system has been placed on the boundary portion between the upper bevel portion and the flat portion;

FIG. 7 is a schematic view showing the relationship between a blurred image of the flat portion and the actual flat portion;

FIG. 8A is a schematic view showing connected images of the apex portion, and FIG. 8B is a schematic view showing connected images of the apex portion in which the actual flat portion is superimposed on a blurred image of the flat portion and;

FIG. 9 is a schematic view showing a modification example of the observation method;

FIG. 10 is a schematic structural view showing the observation device according to the first modification example;

and

FIG. 11 is a schematic structural view showing the observation device according to the second modification example.

### DESCRIPTION OF EMBODIMENTS

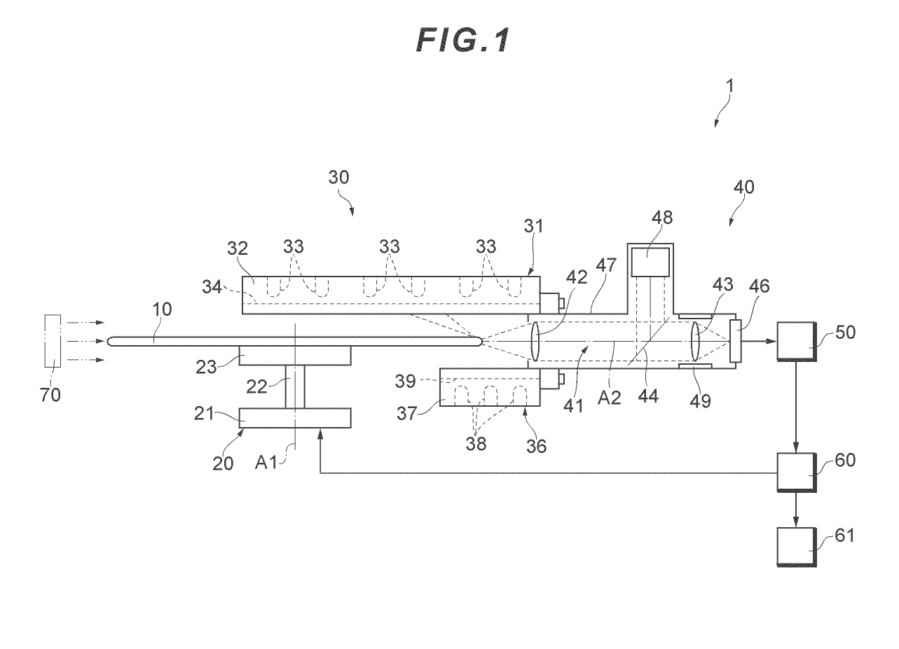

Preferred embodiments of the present invention are described below. An example of the observation device according to the present invention is shown in FIG. 1, and the observation device 1 is used for visual observation by an observer to detect the presence of abnormalities in an end or near the end of a semiconductor wafer 10 (hereinafter referred to as “wafer 10”).

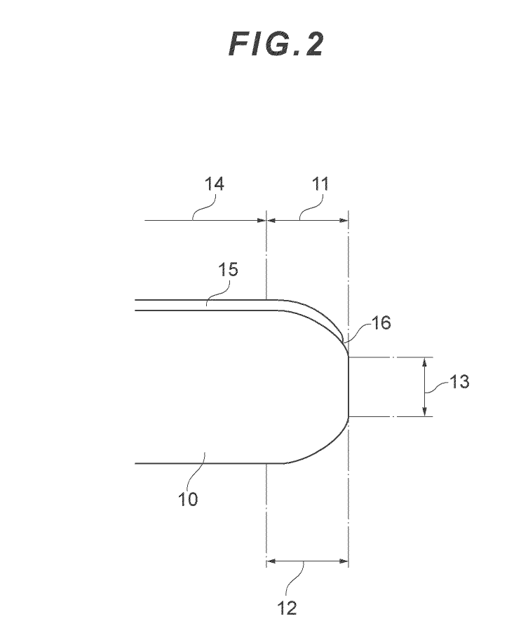

The wafer 10, which is a substrate, is formed in a thin circular shape, and a thin protective film 15 is formed on the surface thereof, as shown in FIG. 2. An upper bevel portion 11 that slopes facing the external peripheral end side of the wafer 10 is formed in the shape of a ring inside the external peripheral end in the surface (upper surface) of the wafer 10, and a flat portion 14 that is substantially flat is formed inside the upper bevel portion 11. Also, a lower bevel portion 12 is formed in obverse/reverse symmetry with the upper bevel portion 11 about the wafer 10 inside the external peripheral end of the reverse surface (lower surface) of the wafer 10. The wafer end surface connected to the upper bevel portion 11 and the bevel portion 12 is the apex portion 13.

The observation device 1 is principally composed of a wafer holding mechanism 20 for rotatably holding the wafer 10, an illumination section 30 for illuminating the vicinity of the external peripheral end of the wafer 10 held by the wafer holding mechanism 20, an imaging section 40 for imaging the vicinity of the external peripheral end of the wafer 10 held by the wafer holding mechanism 20, an imaging processing section 50 for carrying out predetermined image processing of the image of the wafer 10 imaged by the imaging section 40, and a controller section 60 for driving and controlling the wafer holding mechanism 20, the illumination section 30, the imaging section 40, and the like.

The wafer holding mechanism 20 has a base 21, a rotating shaft 22 provided so as to extend vertically upward from the base 21, and a wafer holder 23 mounted horizontally to the upper end portion of the rotating shaft 22 and used for supporting the wafer 10 on the upper surface side. A vacuum-chucking mechanism (not shown) is disposed inside the wafer holder 23, and the wafer 10 on the wafer holder 23 is chucked and held by the vacuum chucking of the vacuum chucking mechanism. The wafer holder 23 is formed in a substantially discoid shape with a smaller diameter than the wafer 10, and the vicinity of the external peripheral end of the wafer 10 including the upper bevel portion 11, the bevel portion 12, and the apex portion 13 protrudes from the wafer holder 23 in a state in which the wafer 10 is chucked and held on the wafer holder 23.

A rotating drive mechanism (not shown) for rotatably driving the rotating shaft 22 is disposed inside the base 21, and the wafer 10 chucked and held on the wafer holder 23 is rotatably driven together with the wafer holder 23 mounted on the rotating shaft 22 about the axis of rotation at the center (axis A1 of rotational symmetry) of the wafer 10 by rotating the rotating shaft 22 by using the rotating driver mechanism. The center of the wafer 10 and the center of the rotating shaft 22 are substantially aligned by an alignment mechanism (not shown). The base 21 is configured so as to allow parallel movement in a horizontal plane using an XY table (not shown), and the wafer 10 chucked and held on the wafer holder 23 can move parallel in the horizontal plane in order to correct for shifting of the center (axis A1 of rotational symmetry) of the wafer 10 in accompaniment with the rotation of the wafer 10. Shifting of the center of the wafer 10 is detected by a sensor (not shown). In this manner, the wafer holding mechanism 20 rotatably holds the wafer 10 so as to allow parallel movement in a horizontal plane.

The illumination section 30 has a first diffusion illumination source 31 disposed facing the obverse surface (upper surface) of the wafer 10, a second diffusion illumination source 36 disposed facing the reverse surface (lower surface) of the wafer 10, and an epi-illumination source 48 disposed in the imaging section 40. The first diffusion illumination source 31 has a first plate member 32 extending in the radial direction of the wafer 10, a plurality of first LED illumination sources 33 mounted on the first plate member 32, and a first diffusion plate 34 for covering the obverse surface (lower surface) side of the first plate member 32 facing the obverse surface of the wafer 10; and is designed to illuminate the vicinity of the external peripheral end of the wafer 10 by using the diffused light obtained from the first LED illumination sources 33 through the first diffusion plate 34. The first diffusion plate 34 is formed in the shape of a plate using an acrylic plate or the like with a milky-white color or roughened surface.

The second diffusion illumination source 36 has the same configuration as the first diffusion illumination source 31, has a second plate member 37, second LED illumination sources 38, and a second diffusion plate 39, and is designed to illuminate the vicinity of the external peripheral end of the wafer 10 by using diffused light obtained from the second LED illumination sources 38 through the second diffusion plate 39. The second diffusion illumination source 36 is disposed on the reverse surface (lower surface) side of the wafer 10, and is formed to be smaller than the first diffusion illumination source 31 so as to avoid interference with the wafer holding mechanism 20. The epi-illumination source 48 will be later described.

The imaging section 40 has an observation optical system 41 for forming an image of the vicinity of the external peripheral end of the wafer 10; a CCD, a CMOS, or another imaging element 46 for imaging the image in the vicinity of the external peripheral end of the wafer 10 and formed by the observation optical system 41; and a case section 47 for accommodating observation optical system 41 and the imaging element 46. The epi-illumination source 48 and a lens drive section 49 are provided to the imaging section 40, and these are also accommodated in the case section 47.

The observation optical system 41 has an objective lens 42 that faces the apex portion 13 of the wafer 10 and in which the optical axis is substantially aligned with the center of the thickness direction of the wafer 10; an imaging lens 43 for forming the light from the objective lens 42 into an image on the imaging surface of the imaging element 46; and an epi-mirror 44, which is a half mirror arranged between the objective lens 42 and the imaging lens 43. Illumination light from the epi-illumination source 48 is reflected by the epi-mirror 44 to illuminate the vicinity of the external peripheral end of the wafer 10 via the objective lens 42; the reflected light from the wafer 10 is directed to the imaging element 46 via the objective lens 42, the epi-mirror 44, and the imaging lens 43; and the imaging element 46 images the image of the vicinity of the external peripheral end (near the apex portion 13) of the wafer 10 that is formed on the imaging surface of the imaging element 46.

The imaging section 40 is arranged so as to face the apex portion 13 of the wafer 10 and is designed to partially image the apex portion 13 from the direction orthogonal to the axis of rotation (axis A1 of rotational symmetry) of the wafer 10 (i.e., the direction in which the wafer 10 extends and the direction facing the apex portion 13). Therefore, when the wafer 10 held in the wafer holding mechanism 20 is rotated, the imaging section 40 arranged so as to face the apex portion 13 is capable of imaging the apex portion 13 a plurality of times in consecutive fashion in the peripheral direction (i.e., relative rotational direction) and is capable of imaging the apex portion 13 around the entire periphery of the wafer 10 because the external peripheral end of the wafer 10, i.e., the apex portion 13 is rotated in a relative fashion in the peripheral direction of the wafer 10 in relation to the imaging region of the imaging section 40. The image data imaged by the imaging element 46 of the imaging section 40 is outputted to the imaging processing section 50. The lens drive section 49 is capable of changing the (foreside) focus position of the observation optical system 41 by moving the imaging lens 43 along the optical axis A2 of the observation optical system 41.

The controller section 60 is composed of a controller substrate and the like for carrying out various controls, and operates and controls the wafer holding mechanism 20, the illumination section 30, the imaging section 40, the imaging processing section 50, and the like by control signals from the controller section 60. Electrically connected to the controller section 60 are an interface section 61 provided with an operation section for operating or otherwise controlling a cursor on an image display section and an image, a storage section (not shown) for storing image data and the thickness information and the like of the wafer 10, and other components.

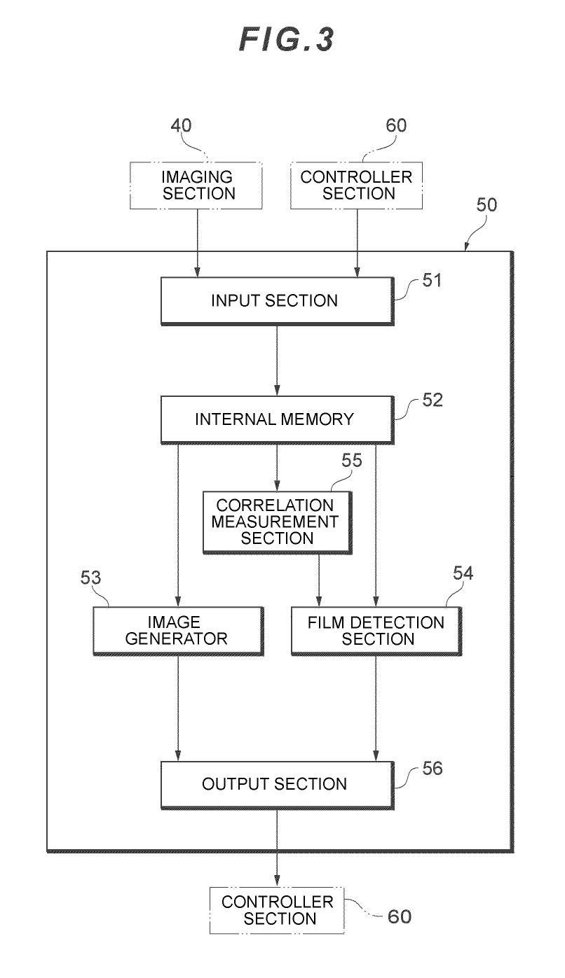

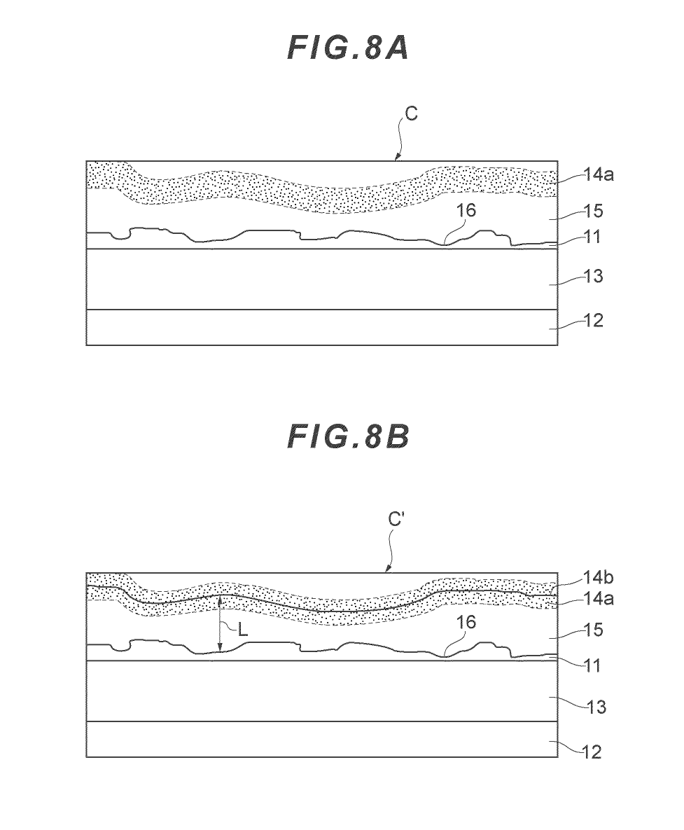

The imaging processing section 50 is composed of a circuit board (not shown) or the like, and has an input section 51, an internal memory 52, an image generator 53, a film detection section 54, a correlation measurement section 55, and an output section 56, as shown in FIG. 3. Image data is inputted from the imaging section 40 to the input section 51, and various parameter settings and the like are inputted using the interface section 61 via the controller section 60. The image data of the wafer 10 (apex portion 13) inputted to the input section 51 is sent to the internal memory 52. The image generator 53 is electrically connected to the internal memory 52, performs predetermined image processing on the basis of a plurality of image data stored in the internal memory 52, and generates and outputs to the output section 56 connected images C (see FIG. 8A) of the apex portion 13 in which the partial images of the apex portion 13 are connected in the peripheral direction.

The film detection section 54 is electrically connected to the internal memory 52, and performs film detection processing (described hereunder) on the basis of image data when the image data is inputted from the internal memory 52. The correlation measurement section 55 is electrically connected to the internal memory 52, and performs (described hereunder) correlation measurement processing on the basis of image data when the image data is inputted from the internal memory 52.

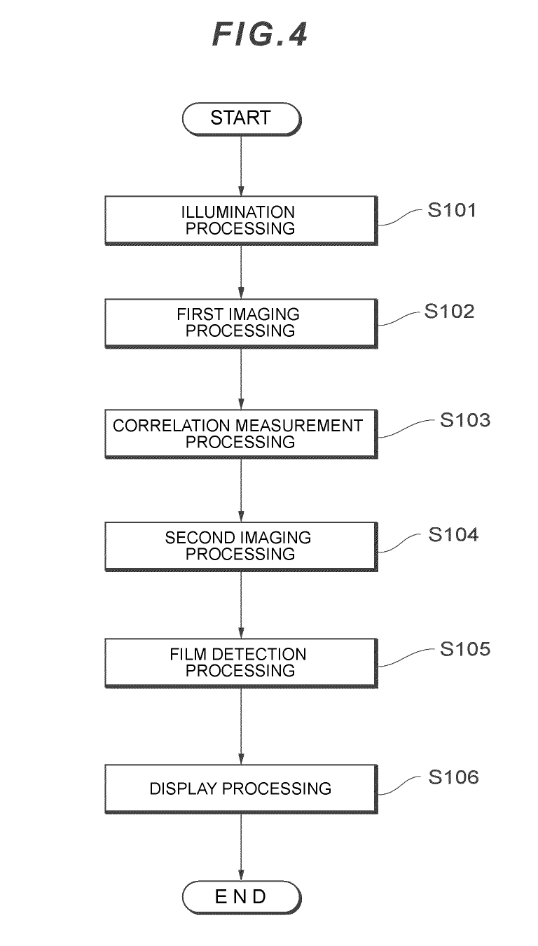

Next, the method for observing the wafer 10 by using the observation device 1 configured in the manner described above will be described below with reference to the flowchart shown in FIG. 4. First, in step S101, illumination processing is carried out for illuminating the vicinity of the external peripheral end (near the apex portion 13) of the wafer 10. In this illumination processing, a control signal is received from the controller section 60, the epi-illumination source 48 illuminates the vicinity of the external peripheral end of the wafer 10 via the objective lens 42 and the epi-mirror 44 the observation optical system 41, and the first diffusion illumination source 31 and the second diffusion illumination source 36 of the illumination section 30 illuminates the vicinity of the external peripheral end of the wafer 10 by using diffused light.

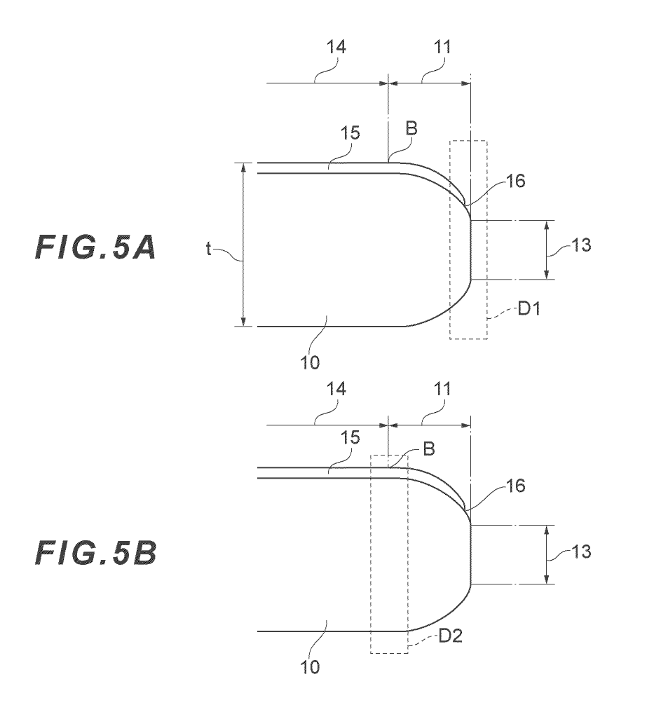

Next, in step S102, a first imaging processing is carried out for imaging the vicinity of the apex portion 13 of the wafer 10. In the first imaging processing, a control signal is received from the controller section 60, and the imaging section 40 images the apex portion 13 in a state in which the wafer holding mechanism 20 has stopped the wafer 10 in a predetermined rotational angle position. At this time, the imaging lens 43 is moved along the optical axis A2 of the observation optical system 41 by using the lens drive section 49, whereby the imaging section 40 images the vicinity of the apex portion 13 of the wafer 10 by using the imaging element 46 in a state in which the focus position (range D1 of the depth of focus) of the observation optical system 41 has been placed on the edge 16 of the protective film 15, as shown in FIG. 5A, and in a state in which the focus position (range D2 of the depth of focus) of the observation optical system 41 has been placed on the boundary portion B between the upper bevel portion 11 and the flat portion 14, as shown in FIG. 5B. The image data imaged by the imaging element 46 of the imaging section 40 is inputted to the imaging processing section 50. The image data inputted from the imaging section 40 are inputted to the input section 51 of the imaging processing section 50 and sent to the internal memory 52.

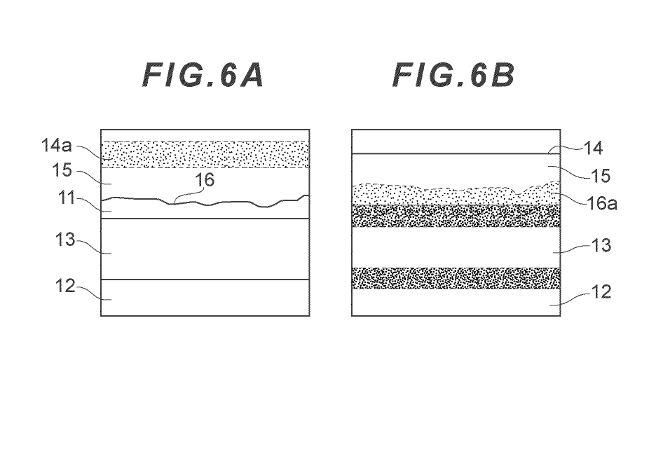

The imaging section 40 (observation optical system 41) in the present embodiment has a sufficient numerical aperture for clearly imaging the apex portion 13 of the wafer 10, and the ranges D1, D2 of the depth of focus of the observation optical system 41 are very small, as shown in FIGS. 5A and 5B. Accordingly, when an image of the vicinity of the apex portion 13 of the wafer 10 is imaged by the imaging element 46 in a state in which the focus position (range D1 of the depth of focus) of the observation optical system 41 has been placed on the edge 16 of the protective film 15, as shown in FIG. 5A, the image clearly shows the edge 16 of the protective film 15 and the apex portion 13 aligned with the focus position, but the focus is blurred on the flat portion 14 away from the focus position and a blurred image 14a of the flat portion is projected, as shown in FIG. 6A. On the other hand, when the image near the apex portion 13 is imaged in a state in which the focus position (range D2 of the depth of focus) of the observation optical system 41 has been placed on the boundary portion B between the upper bevel portion 11 and the flat portion 14, as shown in FIG. 5B, the image clearly shows flat portion 14 (boundary portion B) aligned with the focus position, but the focus is blurred at the edge 16 of the protective film 15 and the apex portion 13 away from the focus position, and a blurred image 16a of the of the edge of the protective film 15 and a blurred image of the boundary between the apex portion 13 and the bevel portions 11, 12 are projected, as shown in FIG. 6B.

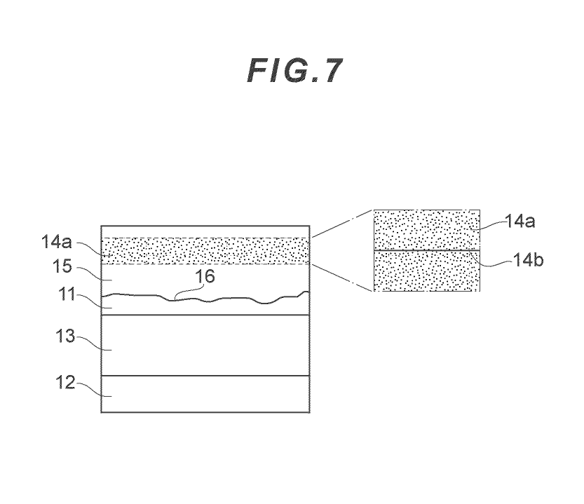

In view of the above, correlation measurement processing is performed in the next step S103. In the correlation measurement processing, the correlation measurement section 55 calculates the correlation between the position of the blurred image 14a of the flat portion and the position of the actual flat portion 14b in the image of the vicinity of the apex portion 13 in which the focus position (range D1 of the depth of focus) of the observation optical system 41 has been aligned with the edge 16 of the protective film 15, using the image data stored in the internal memory 52, i.e., image data in the vicinity of the apex portion 13 in which the focus position (range D1 of the depth of focus) of the observation optical system 41 has been place on the edge 16 of the protective film 15, and the image data in the vicinity of the apex portion 13 in which the focus position (range D2 of the depth of focus) of the observation optical system 41 has been placed on the boundary portion B of the upper bevel portion 11 and the flat portion 14 (see also FIG. 7).

The position of the actual flat portion 14b can be calculated from the image data of the vicinity of the apex portion 13 in which the focus position (range D2 of the depth of focus) of the observation optical system 41 has been placed on the boundary portion B between the upper bevel portion 11 and the flat portion 14 because, although the focus position of the observation optical system 41 changes, the image region does not vary between the two types of images imaged by the first imaging processing. The position of the blurred image 14a of the flat portion can be calculated from the image data of the vicinity of the apex portion 13 in which the focus position (range D1 of the depth of focus) of the observation optical system 41 has been placed on the edge 16 of the protective film 15. Accordingly, the correlation measurement section 55 can calculate the correlation between the position of the blurred image 14a of the flat portion and the position of the actual flat portion 14b from the position data of the blurred image 14a of the flat portion calculated in the manner described above and the position data of the actual flat portion 14b, and output the correlation data thus calculated to the film detection section 54.

When the correlation between the position of the blurred image 14a of the flat portion and the position of the actual flat portion 14b is calculated by using the correlation measurement section 55, second imaging processing is carried out in the next step S104 in order to image the apex portion 13 of the wafer 10 around entire wafer 10. In the second imaging processing, the wafer holding mechanism 20, having received a control signal from the controller section 60, rotates the wafer 10, the imaging section 40 sequentially (in the peripheral direction) picks up a plurality of images of the apex portion 13 rotated in a relative fashion in the peripheral direction of the wafer 10, and images the apex portion 13 around the entire periphery of the wafer 10.

When the imaging section 40 sequentially images the apex portion 13, a plurality of partial images of the apex portion 13 is obtained in each imaging region of the imaging section 40 by the relative movement of the rotating wafer 10, and the image data of the partial images is outputted to the imaging processing section 50. At this point, the imaging section 40 picks up an image of the vicinity of the apex portion 13 of the wafer 10 by using the imaging element 46 in a state in which the focus position (range D1 of the depth of focus) of the observation optical system 41 has been placed on the edge 16 of the protective film 15 by moving the imaging lens 43 along the optical axis A2 of the observation optical system 41 using the lens drive section 49, as shown in FIG. 5A. The image data of the partial images outputted from the imaging section 40 is inputted to the input section 51 of the imaging processing section 50 and sent to the internal memory 52.

When the partial images of the apex portion 13 around the entire periphery of the wafer 10 are imaged by the imaging section 40, the film detection processing is carried out in the next step S105. In the film detection processing, the film detection section 54 detects the position of the edge 16 of the protective film 15 on the basis of the image data of the vicinity of the apex portion 13 in which the focus position (range D1 of the depth of focus) of the observation optical system 41 has been placed on the edge 16 of the protective film 15, the image data being stored in the internal memory 52; detects the position of the flat portion 14 by using the correlation data calculated by the correlation measurement section 55 (i.e., the position of the actual flat portion 14b in an image of the vicinity of the apex portion 13 in which the focus position of the observation optical system 41 has been placed on the edge 16 of the protective film 15); and calculates the distance L between the flat portion 14 (the actual flat portion 14b) and the edge 16 of the protective film 15 in the thickness direction of the wafer 10 (see FIG. 8B). The distance L between the flat portion 14 and the edge 16 of the protective film 15 in the thickness direction of the wafer 10 is calculated for each predetermined interval (pixel) around the entire periphery of the wafer 10; and the data of the distance L calculated around the entire periphery of the wafer 10 is outputted to the output section 56, sent to the internal memory 52 via the controller section 60, and stored in the internal memory 52.

When the distance L between the flat portion 14 and the edge 16 of the protective film 15 in the thickness direction of the wafer 10 is calculated, display processing is carried out in the next step S106. In the display processing, the image generator 53 carries out predetermined image processing on the basis of the image data of the plurality of partial images stored in the internal memory 52, and generates and outputs to the output section 56 connected images C (see FIG. 8A) of the apex portion 13 in which the partial images of the apex portion 13 are connected in the peripheral direction. The image data of the connected images C outputted to the output section 56 is sent to the internal memory 52 via the controller section 60 and stored in the internal memory 52. The controller section 60 causes the image display section of the interface section 61 to display the connected images C of the apex portion 13 and the distance L between the flat portion 14 and the edge 16 of the protective film 15 in the thickness direction of the wafer 10, which are stored in the internal memory 52. The image generator 53 can also generate connected images C′ (see FIG. 8B) in which the actual flat portion 14b is superimposed on the blurred image 14a of the flat portion by using the correlation data calculated by the correlation measurement section 55.

As a result, in accordance with the observation device 1 and the observation method of the present embodiment, the vicinity of the external peripheral end of the wafer 10 is illuminated by the epi-illumination source 48 disposed in the imaging section 40 via the observation optical system 41, and the vicinity of the external peripheral end of the wafer 10 is illuminated using diffused light from the first and second diffusion illumination sources 31, 32. Therefore, the vicinity of the external peripheral end of the wafer 10 can be substantially uniformly illuminated and the edge 16 of the protective film 15 formed on the surface of the wafer 10 can be detected with high precision.

At this point, it is possible to obtain clear images with the focus positions in the positions in which detection is desired, and it is possible to detect the edge 16 of the protective film 15 with high precision even in an optical system having a small depth of focus, by calculating the distance L between the flat portion 14 and the edge 16 of the protective film 15 in the thickness direction of the wafer 10 by using the image data of the vicinity of the apex portion 13 in which the focus position of the observation optical system 41 has been placed on the edge 16 of the protective film 15, and the image data of the vicinity of the apex portion 13 in which the focus position of the observation optical system 41 has been placed on the boundary portion B between the upper bevel portion 11 and the flat portion 14.

Also at this time, it is possible to minimize the imaging operation in which the focus position of the observation optical system 41 has been placed on the boundary portion B between the upper bevel portion 11 and the flat portion 14, and it is possible to detect the edge 16 of the protective film 15 with high precision, by calculating the distance L between the flat portion 14 and the edge 16 of the protective film 15 in the thickness direction of the wafer 10 by detecting the position of the edge 16 of the protective film 15 and detecting the position of the flat portion 14 by using the correlation between the position of the blurred image 14a of the flat portion and the position of the actual flat portion 14b, on the basis of the image data of the vicinity of the apex portion 13 in which the focus position of the observation optical system 41 has been placed on the edge 16 of the protective film 15. This is particularly effective in the case that the vicinity of the apex portion 13 of the wafer 10 is sequentially imaged around the entire periphery of the wafer 10 by the imaging section 40, and the distance L between the flat portion 14 and the edge 16 of the protective film 15 in the thickness direction of the wafer 10 is calculated around the entire periphery of the wafer 10.

As described above, the focus position of the observation optical system 41 can be changed using a minimal configuration by modifying the focus position of the observation optical system 41 by using the lens drive section 49 to move the imaging lens 43 along the optical axis A2 of the observation optical system 41. Changing the focus position of the observation optical system 41 in relation to the wafer 10 is not limited to the imaging lens 43; it is also possible to move the objective lens 42 (along the optical axis A2 of the observation optical system 41) using a drive device (not shown), and it is also possible to move the entire imaging section 40 (observation optical system 41) (along the optical axis A2 of the observation optical system 41).

Rather than moving any of the optical elements in the imaging section 40 (observation optical system 41), it is also possible to change the focus position of the observation optical system 41 in relation to the wafer 10 by moving the wafer 10 parallel along the optical axis of the observation optical system 41 by using the wafer holding mechanism 20. In this manner, the same effect can be obtained in the case any of the optical elements in the imaging section 40 (observation optical system 41) are moved.

In the embodiment described above, the apex portion 13 is imaged around the entire periphery of the wafer 10 in the second imaging processing; however, no limitation is imposed thereby, it also being possible to image only a desired angular position range of the apex portion 13 via the operation control of the controller section 60. It is thereby possible to inspect for the existence of abnormalities only in a desired angular position range of the apex portion 13.

In the embodiment described above, it is also possible to irradiate laser light having a predetermined color using a laser device 70 (see the two-dot chain line of FIG. 1) from the direction of the side opposite from imaging section 40 using the center of the wafer 10 (axis A1 of rotational symmetry) as a reference. In such a configuration, since laser light having high directivity proceeds substantially parallel to the flat portion 14 of the wafer 10 and arrives at the imaging element 46 of the imaging section 40, the boundary portion between the wafer 10 and the laser light is projected as the flat portion, even when the blurred image 14a of the flat portion is projected in the image of the vicinity of the apex portion 13 in which the focus position of the observation optical system 41 has been placed on the edge 16 of the protective film 15. Such a configuration allows the position of the flat portion 14 to be detected and the distance L between the flat portion 14 and the edge 16 of the protective film 15 in the thickness direction of the wafer 10 to be calculated from the image data of the vicinity of the apex portion 13 in which the focus position of the observation optical system 41 has been placed on the edge 16 of the protective film 15, without using the first imaging processing, the correlation measurement processing, and the correlation data obtained from the correlation measurement section 55.

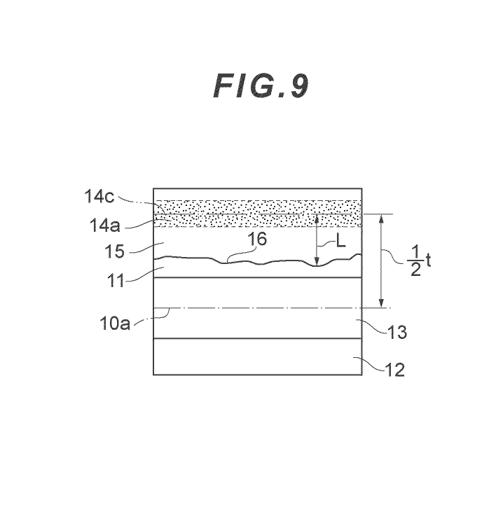

Also, in the embodiment described above, it is possible for the film detection section 54 to detect the position of the edge 16 of the protective film 15 on the basis of the image data of the vicinity of the apex portion 13 in which the focus position of the observation optical system 41 has been placed on the edge 16 of the protective film 15, to detect the center position 10a in the thickness direction of the wafer 10 and the position of the flat portion 14 from the thickness t of the wafer 10 (see FIG. 5A) stored in the storage section (not shown), as shown in FIG. 9, and to calculate the distance L between the flat portion 14 and the edge 16 of the protective film 15 in the thickness direction of the wafer 10. In this configuration as well, the position of the flat portion 14 can be detected and the distance L between the flat portion 14 and the edge 16 of the protective film 15 in the thickness direction of the wafer 10 can be calculated from the Image data of the vicinity of the apex portion 13 in which the focus position of the observation optical system 41 has been placed on the edge 16 of the protective film 15, without using the first image processing, the correlation measurement processing, or the correlation data obtained from the correlation measurement section 55. The center position 10a in the thickness direction of the wafer 10 can be calculated as the intermediate position between the boundary portions by, e.g., detecting the positions of the boundary portions between the apex portion 13 and the bevel portions 11, 12.

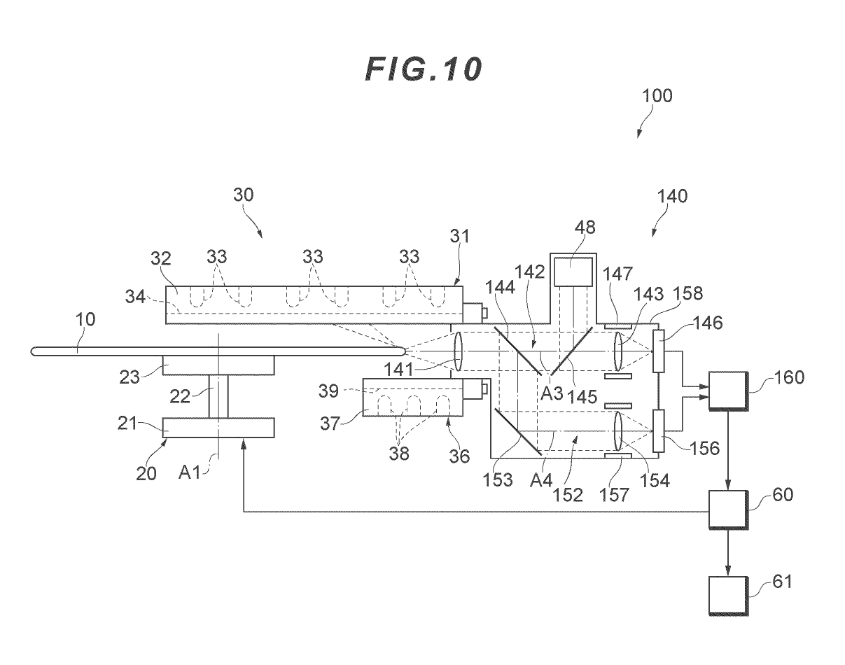

In the embodiment described above, it is also possible to simultaneously pick up an image of the vicinity of the apex portion 13 in which the focus position of the observation optical system 41 has been placed on the edge 16 of the protective film 15, and an image of the vicinity of the apex portion 13 in which the focus position of the observation optical system has been placed on the boundary portion B between the upper bevel portion 11 and the flat portion 14, as shown, e.g., in FIG. 10; to detect the position of the edge 16 of the protective film 15 from the image of the vicinity of the apex portion 13 in which the focus position of the observation optical system has been placed on the edge 16 of the protective film 15; to detect the position of the flat portion 14 from the image of the vicinity of the apex portion 13 in which the focus position of the observation optical system has been placed on the boundary portion B between the upper bevel portion 11 and the flat portion 14; and to calculate the distance L between the flat portion 14 and the edge 16 of the protective film 15 in the thickness direction of the wafer 10. In this configuration as well, the distance L between the flat portion 14 and the edge 16 of the protective film 15 in the thickness direction of the wafer 10 can be calculated without using the correlation data obtained by the correlation measurement section 55.

In an observation system 100 according to a first modification example shown in FIG. 10, an imaging section 140 has a first observation optical system 142 (including an objective lens 141 and a half mirror 144) for forming an image of the vicinity of the external peripheral end (the vicinity of the apex portion 13) of the wafer 10; a CCD, a CMOS, or another imaging element 146 for imaging the image in the vicinity of the external peripheral end of the wafer 10 and formed by the first observation optical system 142; a second observation optical system 152 (including an objective lens 141 and a half mirror 144) for forming an image of the vicinity of the external peripheral end of the wafer 10; a CCD, a CMOS, or another second imaging element 156 for imaging the image in the vicinity of the external peripheral end of the wafer 10 and formed by the second observation optical system 152, and a case section 158 for accommodating these components. The epi-illumination source 48 and first and second lens drive sections 147, 157 are provided to the imaging section 140, and these are also accommodated in the case section 158.

Illumination light from the epi-illumination source 48 is reflected by the epi-mirror 145 to illuminate the vicinity of the external peripheral end of the wafer 10 via the half mirror 144 and the objective lens 141. Half of the reflected light from the wafer 10 passes through the objective lens 141 and the first observation optical system 142 and is directed to the first imaging element 146 via the epi-mirror 145 and a first imaging lens 143 constituting the first observation optical system 142; and a first imaging element 146 images an image of the vicinity of the external peripheral end (vicinity of the apex portion 13) of the wafer 10 formed on the imaging surface of the first imaging element 146. On the other hand, the other half of the light reflected from the wafer 10 passes through the objective lens 141, is reflected by the half mirror 144, and is directed to the second imaging element 156 via a reflective mirror 153 and a second imaging lens 154 constituting the second observation optical system 152; and the second imaging element 156 images an image of the vicinity of the external peripheral end (vicinity of the apex portion 13) of the wafer 10 formed on the imaging surface of the second imaging element 156.

The first lens drive section 147 is capable of placing the (foreside) focus position of the first observation optical system 142 on the edge 16 of the protective film 15 by moving the first imaging lens 143 along the optical axis A3 of the first observation optical system 142. The second lens drive section 157 is capable of placing the (foreside) focus position of the second observation optical system 152 on the boundary portion B between the upper bevel portion 11 and the flat portion 14 by moving the second imaging lens 154 along the optical axis A4 of the second observation optical system 152. It is thereby possible to simultaneously obtain an image of the vicinity of the apex portion 13 in which the focus position of the observation optical system has been placed on the edge 16 of the protective film 15, and an Image of the vicinity of the apex portion 13 in which the focus position of the observation optical system has been placed on the boundary portion B between the upper bevel portion 11 and the flat portion 14.

The image data formed by the first imaging element 146 and the second imaging element 156 are outputted to an image processing section 160. The film detection section (not shown) of the image processing section 160 detects the position of the edge 16 of the protective film 15 from the image of the vicinity of the apex portion 13 in which the focus position of the observation optical system has been placed on the edge 16 of the protective film 15; detects the position of the flat portion 14 from an image of the vicinity of the apex portion 13 in which the focus position of the observation optical system has been placed on the boundary portion B between the upper bevel portion 11 and the flat portion 14; and calculates the distance L between the flat portion 14 and the edge 16 of the protective film 15 in the thickness direction of the wafer 10. The relationship between the focus positions of the first observation optical system 142 and the second observation optical system 152 may be reversed.

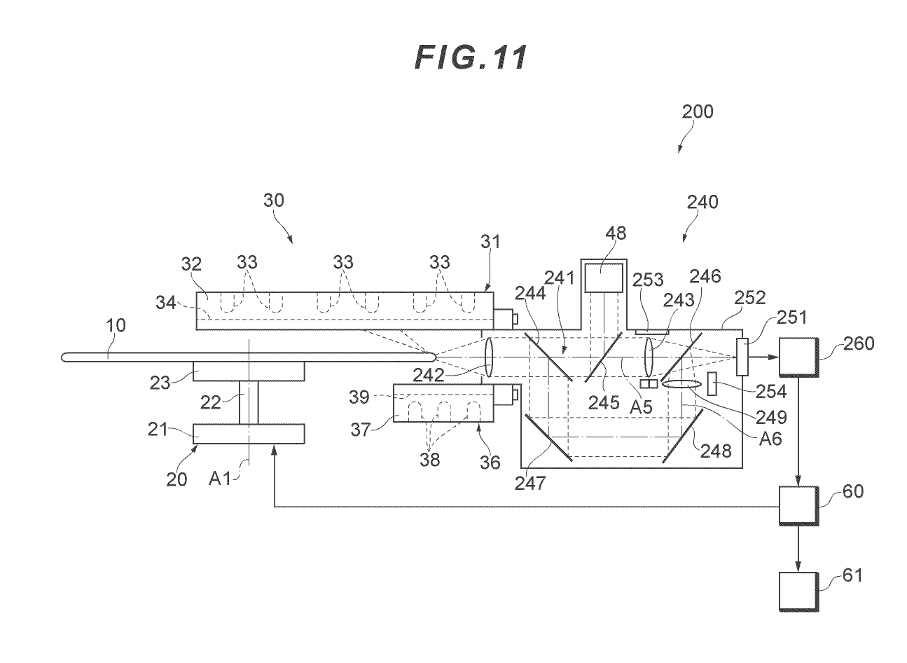

The same effect as that shown in FIG. 10 can be obtained even when a configuration such as that shown in FIG. 11 is used. In an observation device 200 according to a second modification example shown in FIG. 11, an imaging section 240 has an observation optical system 241 for forming an image of the vicinity of the external peripheral end (the vicinity of the apex portion 13) of the wafer 10; a CCD, a CMOS, or another imaging element 251 for imaging the image in the vicinity of the external peripheral end of the wafer 10 and formed by the observation optical system 241; and a case section 252 for accommodating these components. The epi-illumination source 48 and first and second lens drive sections 253, 254 are provided to the imaging section 240, and these are also accommodated in the case section 252.

Illumination light from the epi-illumination source 48 is reflected by an epi mirror 245 to illuminate the vicinity of the external peripheral end of the wafer 10 via a first half mirror 244 and an objective lens 242. Half of the reflected light from the wafer 10 passes through the objective lens 242 and the first half mirror 244 of the observation optical system 241, and is furthermore directed to the imaging element 251 via the epi-mirror 245, the first imaging lens 243, and a second half mirror 246. On the other hand, the other half of the light reflected from the wafer 10 passes through the objective lens 242, is reflected by the first half mirror 244, and is furthermore directed to a first reflective mirror 247, a second reflective mirror 248, a second imaging lens 249, and a second half mirror 246.

The first lens drive section 253 is capable of placing the (foreside) focus position of the first imaging lens system 243 on the edge 16 of the protective film 15 by moving the first Imaging lens 243 along the optical axis AS between the epi-mirror 245 and the second half-mirror 246. The second lens drive section 254 is capable of placing the (foreside) focus position of the optical system including the second imaging lens 249 on the boundary portion B between the upper bevel portion 11 and the flat portion 14 by moving the second imaging lens 249 along the optical axis A6 between the second reflective mirror 248 and the second half-mirror 246. It is thereby possible to use the imaging element 251 to simultaneously pick up an image of the vicinity of the apex portion 13 in which the focus position of the observation optical system has been placed on the edge 16 of the protective film 15, and an image of the vicinity of the apex portion 13 in which the focus position of the observation optical system has been placed on the boundary portion B between the upper bevel portion 11 and the flat portion 14.

The image data imaged by the imaging element 251 are outputted to the image processing section 260. The film detection section (not shown) of the image processing section 260 detects the position of the edge 16 of the protective film 15 on which the focus position has been placed and the position of the flat portion 14 on which the focus position has been placed, from superimposed images of an image of the vicinity of the apex portion 13 in which the focus position of the observation optical system has been placed on the edge 16 of the protective film 15, and an image of the vicinity of the apex portion 13 in which the focus position of the observation optical system has been placed on the boundary portion B between the upper bevel portion 11 and the flat portion 14; and calculates the distance L between the flat portion 14 and the edge 16 of the protective film 15 in the thickness direction of the wafer 10. The relationship between the focus positions of the optical system that includes the first imaging lens 243 and the optical system that includes the second imaging lens 249 may be reversed.

In the embodiments described above including the modification examples, the imaging element is not limited to a 2D image sensor; it also being possible to use a line sensor-type CCD, CMOS, or the like.

### EXPLANATION OF NUMERALS AND CHARACTERS

1: observation device

10: wafer (substrate)

11: upper bevel portion (slope portion)

12: lower bevel portion

13: apex portion

14: flat portion

14a: blurred image of the flat portion

14b: actual flat portion

14c: actual flat portion (modification example)

15: protective film

16: edge (16a: blurred image of the edge)

20: wafer holding mechanism

30: illumination section

31: first diffusion illumination source

36: second diffusion illumination source

40: imaging section

41: observation optical system

46: imaging element

48: epi-illumination source

49: lens driving section (focus modifying section)

50: image processing section

54: film detection section

55: correlation measurement section

60: controller section

61: interface section

70: laser device (opposite-side illumination section)

100: observation device (first modification example)

140: imaging section

142: first observation optical system

146: first imaging element

152: second observation optical system

156: second imaging element

147: first lens driving section

157: second lens driving section

160: image processing section (film detection section)

200: observation device (second modification example)

240: imaging section

241: observation optical system

251: imaging element

253: first lens driving section

254: second lens driving section

260: image processing section (film detection section)

What is claimed:

1. An observation device comprising a holding mechanism configured to hold a substrate, and an imaging section configured to obtain an image of the substrate at a vicinity of an end of the substrate from a direction in which the substrate extends with the substrate being held by the holding mechanism, the vicinity of the substrate end being observed using image data of the vicinity of the substrate end obtained by the imaging section,
wherein the imaging section comprises a first observation optical system having a first focus point at the vicinity of the substrate end, a second observation optical system having a second focus point at the vicinity of the substrate end, and at least one Imaging element to obtain a first image of the vicinity of the substrate end obtained by the first observation optical system and a second image of the vicinity of the substrate end obtained by the second observation optical system, the first focus point being different from the second focus point in an optical axis direction of the first observation optical system and the second observation optical system, and
the observation device further comprises an image processing section configured to produce the image data of the vicinity of the substrate end based on the first image and the second image obtained by the at least one imaging element.

2. The observation device according to claim 1,
wherein the imaging element includes a first imaging element disposed for obtaining the first image and a second imaging element disposed for obtaining the second image, and
the image processing section produces the image data of the vicinity of the substrate end based on first image data of the first image obtained by the first imaging element and second image data of the second image obtained by the second imaging element.

3. The observation device according to claim 1, including an imaging element that makes a combined image of the first image obtained by the first observation optical system and the second image obtained by the second observation optical system, and
wherein the image processing section produces the image data of the vicinity of the substrate end based on the combined image.

4. The observation device according to claim 1,
wherein a surface of the substrate has a slope portion that is formed in the vicinity of the substrate end and is inclined toward the end and a flat portion that is substantially flat and formed inside the sloped portion,
a film formed on the surface of the substrate extends on the sloped portion, and
the first focus point locates at a boundary portion between the sloped portion and the flat portion, and the second focus point locates at a tip end of the film formed on the sloped portion.

5. The observation device according to claim 4,
wherein the image processing section comprises a film detection section which detects the edge of the film based on the Image data of the vicinity of the substrate end.

6. The observation device according to claim 5,
wherein the film detection section detects a distance between the flat portion and the edge of the film in a thickness direction of the substrate using the image data of the vicinity of the substrate end.

7. The observation device according to claim 2,
wherein a surface of the substrate has a slope portion that is formed in the vicinity of the substrate end and is inclined toward the end and a flat portion that is substantially flat and formed inside the sloped portion,
a film formed on the surface of the substrate extends on the sloped portion,
the first focus point locates at a boundary portion between the sloped portion and the flat portion, and the second focus point locates at a tip end of the film formed on the sloped portion,
the image processing section includes a correlation measurement section which measures a correlation between image information of the flat portion in the second image data obtained away from the second focus point of the second observation optical system and an actual position of the flat portion in the second image data, and
the film detection section detects a position of the edge of the film based on the second image data, detects a position of the flat portion based on the correlation measured by the correlation measurement section, and detects a distance between the flat portion and the edge of the film in the thickness direction of the substrate.

8. The observation device according to claim 1,
wherein the substrate is disc-shaped, and the holding mechanism rotatably holds the disc-shaped substrate around an axis of rotational symmetry of the disc, and
the imaging section obtains images of the vicinity of the substrate end continuously over an entire periphery of the substrate while the substrate is rotated by the holding mechanism, and
the image processing section produces image data of the vicinity of the substrate end over the entire periphery.

9. The observation device according to claim 1,
wherein at least one of the first observation optical system and the second observation optical system includes a focus point position changing section adapted to change a position of the focus point of the observation optical system in object-side at the vicinity of the substrate end.

10. The observation device according to claim 1, further comprising:
an epi-illumination system to illuminate the vicinity of the substrate end via an objective lens of the first and the second observation optical systems, and
a diffusion illumination system to illuminate the vicinity of the substrate end using diffused light.

11. The observation device according to claim 1, further comprising:
an opposite-side illumination section to illuminate the substrate toward the imaging section, the opposite-side illumination section being arranged on the opposite side of the substrate from the imaging section.

12. An observation method for observing the vicinity of an end of a substrate using an image of the vicinity of the substrate end, the method comprising:
holding the substrate with a holding mechanism;
obtaining a first image of the vicinity of the substrate end using a first observation optical system having a first focus point at the vicinity of the substrate end;
obtaining a second image of the vicinity of the substrate end using a second observation optical system having a second focus point at the vicinity of the substrate end, the first focus point being different from the second focus point in an optical axis direction of the first observation optical system and the second observation optical system: and
producing image data of the vicinity of the substrate end based on the first image and the second image.

13. The observation method according to claim 12,
wherein a surface of the substrate has a sloped portion that is formed in the vicinity of the substrate end and is inclined toward the end and a flat portion that is substantially flat and formed inside the sloped portion, and a film formed on the surface of the substrate extends on the sloped portion,
the method further comprising the following steps:
illuminating the vicinity of the substrate end; and
detecting an edge of the film using one of the obtained images of the vicinity of the substrate end,
wherein, in the illuminating step, the vicinity of the substrate end is illuminated by an epi-illumination system via one of the first and second observation optical systems.

14. The observation method according to claim 12,
wherein the first image of the vicinity of the substrate end is focused on the boundary portion between the sloped portion and the flat portion and the second image of the vicinity of the substrate end is focused on the edge of the film, and
the edge detecting step includes using the first and the second images of the vicinity of the substrate end to detect a distance between the flat portion and the edge of the film in a thickness direction of the substrate.

15. The observation method according to claim 14, further comprising:
a correlation measurement step, in which, a correlation is measured between image information of the flat portion in the second image data obtained away from the second focus position and an actual position of the flat portion in the second image data,
wherein, in the correlation measurement step, a position of the edge of the film is detected based on the second image, a position of the flat portion is detected based on the measured correlation, and a distance between the flat portion and the edge of the film in the thickness direction of the substrate.

16. The observation method according to claim 15,
wherein the substrate is disc-shaped, and the holding mechanism rotatably holds the disc-shaped substrate around the axis of rotational symmetry of the disc,
images of the vicinity of the substrate end are obtained continuously over the entire periphery while the substrate is rotated by the holding mechanism, and
in the edge detecting step, the distance between the flat portion and the edge position of the film in the thickness direction of the substrate is detected over the entire periphery of the substrate.

17. The observation device according to claim 1,
wherein the first observation optical system and the second observation optical system have an optical axis that extends in the same direction in which the substrate extends with the substrate being held by the holding mechanism, and
the first focus point is different from the second focus point on the optical axis.

18. The observation method according to claim 12,
wherein the first observation optical system and the second observation optical system have an optical axis that extends in the same direction in which the substrate extends with the substrate being held by the holding mechanism, and
the first focus point is different from the second focus point on the optical axis.
